(19) United States
(12) Patent Application Publication
(10) Pub. No.: US 2009/0167227 A1
(43) Pub. Date: Jul. 2, 2009

(54) Method and control device for monitoring and limiting the torque in a drive train of a road motor vehicle

(76) Inventor: Robert Gwinner, Marbach (DE)

Correspondence Address: KENYON & KENYON LLP, ONE BROADWAY, NEW YORK, NY, 10004, US

(21) Appl. No.: 12/316,463

(22) Filed: Dec. 12, 2008

(30) Foreign Application Priority Data
Dec. 20, 2007 (DE) 10 2007 061 722.6
Jun. 24, 2008 (DE) 10 2008 002 623.9

(51) Int. Cl. H02P 6/08

(52) U.S. Cl. 318/434; 180/65.285

(57) ABSTRACT

A method for monitoring and limiting the output or the torque of a drive motor in a drive train of a road motor vehicle, including the steps of: determining a permissible maximum value of the output or the torque as a function of a signal from a driver input sensor; determining an actual value of the output or the torque, and comparing the actual value to the maximum value and triggering a measure that limits the output or the torque as a function of the comparison result. The method is characterized by the repeated formation of a difference from the actual value and the maximum value, formation of a sum of values of a function of the difference, comparison of a value of the sum to a threshold value, and initiation of the measures if the value of the sum is greater than the threshold value. An independent claim is directed to a control device, which is programmed to implement the method.

### FIELD OF THE INVENTION

The present invention relates to a method and control device for monitoring and limiting the torque in a drive train of a road motor vehicle.

### BACKGROUND INFORMATION

A method and a control device of this type are both discussed in DE 195 36 038 A1.

In modern combustion engines, performance-determinative actuators such as a throttle valve are no longer mechanically coupled to a driver-input sensor. Nowadays, a driver-input sensor typically converts a torque request from the driver into an electric signal, from which the control device determines one or a plurality of actuating variables for one or a plurality of performance-regulating final control elements. Malfunctions in the signal-processing chain between the driver-input sensor and the final control elements can therefore induce the combustion engine to generate more torque than the driver desired. To prevent this, in the known subject matter a permissible maximum value of the power output or the torque is determined as a function of a signal from a driver-input sensor, an actual value of the power output or the torque is determined, the actual value is compared to the maximum value, and a measure limiting the power output or the torque is triggered as a function of the comparison result.

In such subject matter, a limitation of the torque acting in the drive drain is initiated when the actual value of the torque exceeds the maximum value determined from the driver input. As an alternative, a limitation is initiated when an actual value of the output transmitted by the drive train exceeds a corresponding maximum value determined from the driver input. In a further development of both alternatives, the limitation is to be initiated when the maximum value is exceeded for longer than a predefined time.

Basic possibilities for limiting the torque are restrictions of the air supply into the combustion chambers of the combustion engine, restrictions of the fuel supply, and reductions in the ignition timing efficiency. The ignition timing efficiency is understood as the quotient from the torque at a particular ignition angle and the torque at an ignition angle that is optimal for the torque development. If the actual value of the torque exceeds a maximally permitted value derived from the driver input, the road motor vehicle could accelerate to an undesired extent or accelerate to a greater extent than desired, which could lead to dangerous driving situations.

Once such an exceedance is detected, a throttle valve serving as air-mass actuating element is usually switched into a de-energized state. Mechanical restoring forces then adjust the throttle valve to a minimum opening position in which the combustion engine continues to run at a considerably reduced torque. However, a switch-off of the combustion engine is avoided so that functions such as steering support or braking support, for example, which require a running combustion engine, continue to be available.

Because of the safety relevance, the monitoring and limiting must, for one, respond in a relatively sensitive manner. For another, erroneously triggered limitations must be avoided since they considerably restrict the drivability of the road motor vehicle and could themselves lead to critical driving situations, for example in a passing maneuver.

### SUMMARY OF THE INVENTION

Against this background, it is an object of the exemplary embodiments and/or exemplary methods of the present invention to provide a method and a control device with whose aid the safety-critical torque developments are detectable even more reliably and by which the risk of faulty and thus unnecessarily undertaken torque-limiting measures is reduced. According to the exemplary embodiments and/or exemplary methods of the present invention, the objective is achieved by the features delineated in the independent claims.

The following advantages result in comparison with current methods and devices for monitoring the torques of the drives: In the known method, the actual value of the current torque was compared to a permissible value. If the permissible value is exceeded, a time counter was activated. If the permissible value was undershot, the time counter was reset. If the value of the time counter exceeded a threshold, an error reaction was triggered. The extent of the exceedance was not evaluated. In a real driving situation, however, a high exceedance has a more critical effect than only a slight exceedance.

In contrast, the exemplary embodiments and/or exemplary methods of the present invention has the advantage that exceedances are recorded in quantitative terms as well and, by the sum operation, are also taken into account in quantitative terms in the decision as to whether or not a fault reaction is to be triggered. Furthermore, the summation (or integration) also provides a value that has a more direct relevance to the effect of the exceedance on the vehicle: A quantitatively greater exceedance causes greater acceleration than only an only smaller exceedance. In the invention, the fault reaction in the case of the greater exceedance is triggered earlier than in the case of the smaller exceedance. Furthermore, a summation or integration of output values instead of torque values has the advantage that the exceedance is able to be evaluated in terms of its effect at the driven wheels regardless of a currently set transmission ratio in the drive train.

If a force transmission to the wheels is taking place, the sum of the power or torque contributions exceeding the threshold value and impermissibly output by the drives describes the impermissible change of the kinetic energy of the vehicle due to a fault, in an approximation that is sufficiently accurate for the control device monitoring. This allows a better evaluation of the effect of the fault on the vehicle. The evaluation of cyclically faulty drive torques is improved. The realization of the control device monitoring in systems having hybrid drive, made up of different combinations of electric machines and combustion engines, is simplified. The consideration of the moments of inertia of switch-selectable drives in the monitoring of the control devices in systems having a hybrid drive is simplified. More specifically, the modeling errors are reduced since, unlike in the case of a direct consideration in the permissible torque or the output, rotational speed gradients need not be taken into account.

Further advantages result from the dependent claims, the description and the attached figures.

It is understood that the aforementioned features and the features yet to be explained hereinafter may be used not only in the indicated combination, but also in other combinations or by themselves, without departing from the scope of the present invention.

Exemplary embodiments of the present invention are shown in the drawing and explained in detail in the following description.

Matching reference numerals denote the same elements.

### BRIEF DESCRIPTION OF THE DRAWINGS

FIG. 1 shows a drive train of a road motor vehicle together with a control of the drive train.

FIG. 2 shows the forming of various performance quantities of the drive train in the control device.

FIG. 3 shows a first exemplary embodiment of the present invention in the form of program structures that are implemented within the control device.

FIG. 4 shows a development in which the power outputs are summed up.

FIG. 5 shows a drive train that differs from the already described drive train by an electric machine, which is able to operate as additional drive motor and/or as generator.

FIG. 6 shows the forming of various performance quantities of the drive train from FIG. 5 in the control device of FIG. 5.

FIG. 7 shows a development in the form of program structures that are implemented within the control device of FIG. 5.

### DETAILED DESCRIPTION

In detail, FIG. 1 shows a drive train 10 of a road motor vehicle together with a control of drive train 10. Drive train 10 in particular has a combustion engine 12, which is coupled to remainder 16 of the drive train via a clutch 14. Clutch 14 may be a friction clutch actuated automatically or by a driver, or a fluid clutch. Remainder 16 of drive train 10 represents additional elements usually provided for the torque transmission between the wheels and drive of the road motor vehicle, such as gear trains and shafts.

In the subject matter of FIG. 1, the drive torque is generated solely by combustion engine 12. To control its torque output, combustion engine 12 is equipped with final control elements 18 by which a charge of the combustion chambers of combustion engine 12 and/or the quality of the charge, i.e., a mixture ratio of fuel and air, for example, and/or the time sequence of the combustion are/is able to be controlled or influenced, for instance by shifting the moments of ignition.

The control of combustion engine 12 is implemented by a control device 20. To form actuating variables S_G_12, control device 20 in the subject matter of FIG. 1 processes signals from sensors 22 (measuring variables M_G_12), 24 and 26, the operating parameters of combustion engine 12 such as the aspirated air mass, rotational speed n_12, excess-air factor Lambda, signal FW from a driver-input sensor 24, and—optionally—operating parameters of the rest of drive train 16, which are provided by a sensor 26, such as a rotational speed of a clutch n_K, for example.

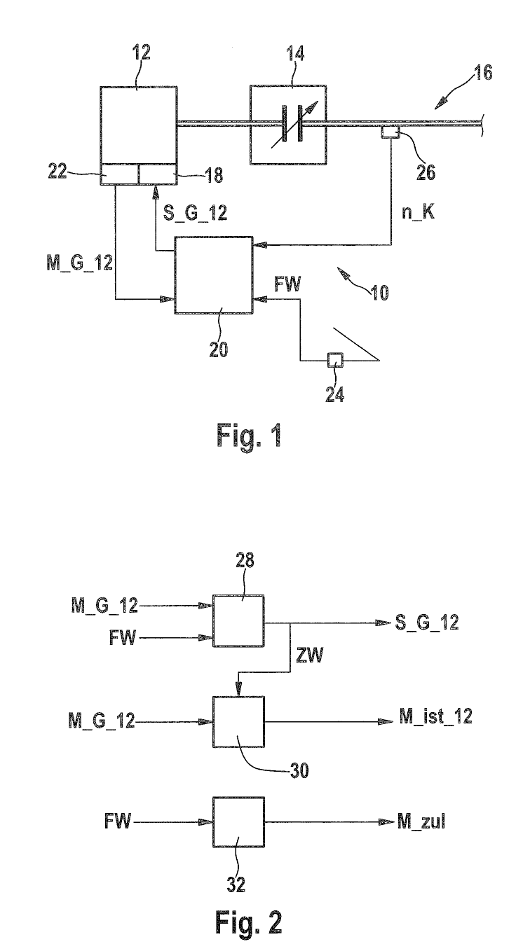

FIG. 2 represents the formation of various performance quantities of drive train 10 in control device 20. Control device 20 is designed, especially programmed, to control drive train 10 and, in particular, to monitor the torque generation and/or the power output of combustion engine 12 in the process, the control device also taking its own actuating variables S_G_12 into account in the monitoring. For this purpose, control device 20 includes, among others, program structures 28, 30 and 32 illustrated in the form of blocks.

Program structure 28 determines from measuring variables M_G_12, which are provided by sensors 22 and represent performance variables of combustion engine 12, e.g., the quantity and quality of the combustion chamber charge, and additionally also from driver input FW, actuating variables S_G_12 for final control elements 18 of combustion engine 12. If all involved components function correctly, the combustion engine will generate a correct torque M_ist_12 according to the requirements.

In program structure 30, the value of torque M_ist_12 actually generated by the combustion engine as a function of driver input FW is modeled from measured variables M_G_12 and/or actuating variables S_G_12 of combustion engine 12. Modeling means a calculation within control device 20. In this context, an essential piece of actuating-variable information is, for example, ignition angle ZW, which is usually not detected as measured variable M_G_12 and thus is usually available only as one of actuating variables S_G_12.

Parallel to forming the value of modeled M_ist_12 in block 30, a maximally permitted value M_zul for the torque generated by combustion engine 12 is formed in program structure 32 from driver input FW or at least as a function of driver input FW. Instead of the torque, it is also possible to model the output of combustion engine 12. The same applies to the determination of a maximally permitted value.

If all involved components function correctly, then modeled actual value M_ist_12 must always be smaller than maximally permitted value M_zul. On the other hand, if M_ist_12 is greater than M_zul, a malfunction of control device 20 or final control element 18 usually has occurred.

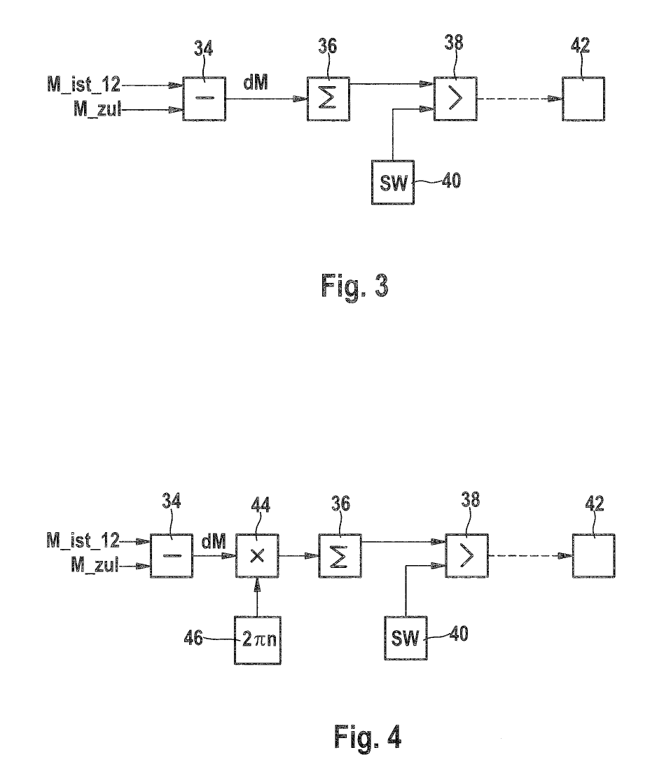

FIG. 3 shows a first exemplary embodiment of the present invention in the form of program structures that are implemented within control device 20. Just like the developments of FIGS. 4 and 7, FIG. 3 thus discloses individual method and device aspects of different developments of the invention introduced here.

In block 34, a difference dM=M_ist_12−M_zul is repeatedly formed from modeled actual value M_ist_12 and maximally permitted value M_zul. In block 36, a sum of a function of values of difference dM will then be formed. In the development of FIG. 3, this function f is identity f(dM)=dM. That is to say, direct values of difference dM are added. In block 38, the value of the sum is then compared to a specified threshold value SW, which is supplied to block 38 by block 40. Block 40 represents a memory cell or a memory area of control device 20, in which a specified fixed value SW or a dependency SW=SW (performance quantity) of performance quantities of combustion engine 12 and/or remainder 16 of drive train 10 is stored.

If the sum determined in block 36 exceeds threshold value SW, then an error reaction is output in block 42. A typical error reaction consists of reducing the combustion chamber charge to a predefined minimum value. In one development, this is done in such a way that a throttle valve serving as charge actuator is no longer triggered to open, so that mechanical restoring forces drive it into a minimum opening position at which combustion engine 12 provides no more than a very low torque. Combustion engine 12 is not completely switched off, however, in order not to deactivate steering-support or brake-force support functions.

Whereas FIG. 3 represents a development in which torque values in the form of difference dM are summed up, FIG. 4 discloses a development in which power outputs are summed up. For this purpose, difference dM formed in block 34 is multiplied in block 44 by two times the π of rotational speed n of combustion engine 12. Product 2πn is supplied by block 46 in this instance. The subsequently summed-up values therefore represent a function f=2πndM of difference dM, and consequently represent power output values.

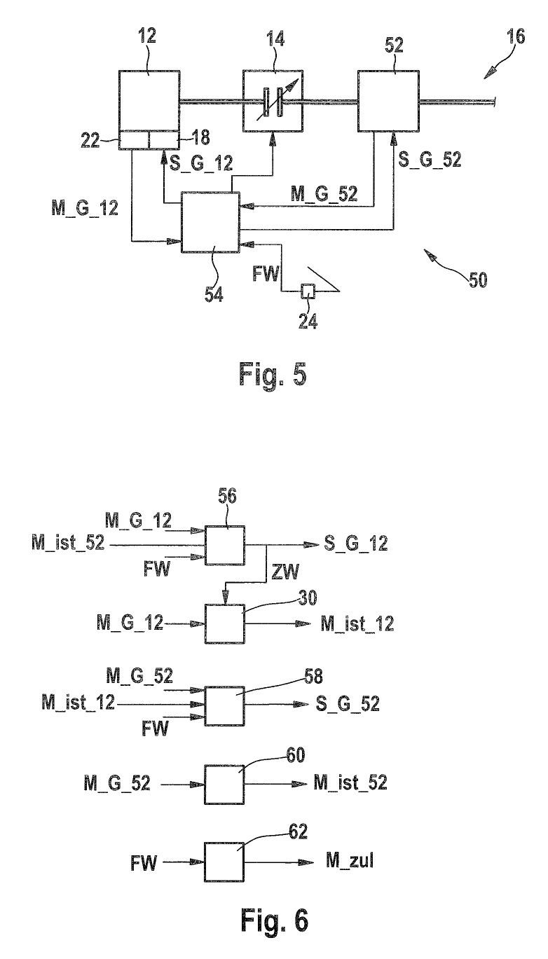

FIG. 5 shows a drive train 50 that differs from already described drive train 10 by an electric machine 52, which is able to operate as additional drive motor and, in one development, as generator as well. Like combustion engine 12, electric machine 52 is controlled by a control device 54. As an alternative, it is also possible to provide a separate control device 54 for the control of electric machine 52, which is connected to control device 20 via a bus system. This analogously applies to the control of clutch 14, which is likewise controlled by control device 20 in the development of FIG. 5. Like control device 20 as well, control device 54 is designed, especially programmed, to control drive train 50 and to monitor its torque- and engine-speed-determinative functions, the control device also taking its own actuating variables S_G_12, S_G_52 into account in the monitoring.

When clutch 14 is disengaged, electric machine 52 serves as drive motor on its own. When clutch 14 is engaged, combustion engine 12 operates as drive motor, either alternatively or additionally. In an exemplary embodiment, when clutch 14 is engaged, electric machine 52 is able to be operated as generator, which is driven by the rolling road motor vehicle by combustion engine 12 or via remainder 16 of the drive train. In one exemplary embodiment, electric machine 52 also serves as starter for combustion engine 12.

FIG. 6 represents the formation of various performance quantities of drive train 50 in control device 54. In block 56, actuating variables SG_12 are formed for the control of final control elements 18 of combustion engine 12. To this extent, block 56 corresponds to block 28 from FIG. 2. One difference to block 28 consists of the fact that block 56 additionally takes an actual value of torque contribution M_ist_52 of electric machine 52 into account as input variable. The torque contribution generated by electric machine 52 reduces the torque contribution that is to be supplied by combustion engine 12.

Like block 30 from FIG. 2, block 30 is used for modeling an actual value M_ist_12 of the torque generated by combustion engine 12.

Block 58 is provided to determine actuating variables SG_52 for the control of electric machine 52. To this end, block 58 processes as input variables driver input FW, measuring variables M_G_52, which reflect operating parameters of electric machine 52, such as its rotational speed n_52, and actual value M_ist_12 of the torque contribution provided by combustion engine 12 and modeled in block 30. The torque contribution provided by combustion engine 12 reduces the torque contribution that is to be supplied by the electric machine.

In block 60, actual value M_ist_52 of the torque contribution supplied by electric machine 52 is modeled from measured variables M_G_52.

Like block 32 of FIG. 2, block 62 is used to determine a marginally still permitted maximum value M_zul for the torque acting in drive train 50. In contrast to block 32 of FIG. 2, maximum value M_zul may also be a negative value, by which the brake torque or the brake power of electric machine 52 is restricted during generator operation.

Drive train 50 from FIG. 5 represents an example of a drive train in a road motor vehicle in which either combustion engine 12 or electric machine 52, or both simultaneously, are used as drive motors. The hybrid drive thus realized is designed in such a way that the power outputs of combustion engine 12 and electric machine 52 at clutch 14 add up. Combustion engine 12 is able to be decoupled by disengaging clutch 14.

In such a hybrid drive, during a ride in which the propulsion initially is provided solely by electric machine 52, for example, combustion engine 12 is to be started. Stationary combustion engine 12 is to be started with the aid of electric machine 52, which also is utilized for the drive, by engaging clutch 14. In the process, the driving power transmitted to the wheels of the road motor vehicle should not vary, or should vary as little as possible. To this end, both a torque loss, determined in quasi-stationary manner, of combustion engine 12 and also a torque required for accelerating combustion engine 12 may be taken into account.

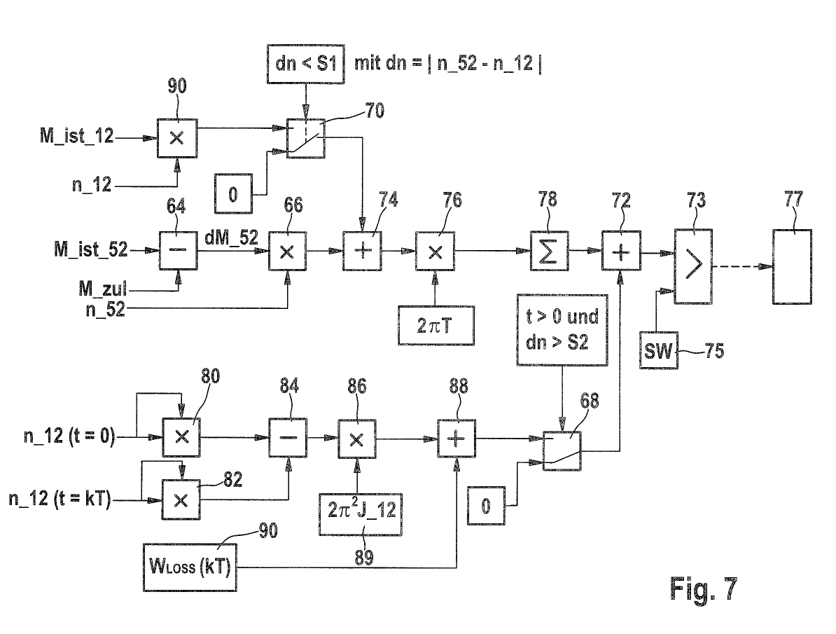

FIG. 7 shows a development in the form of program structures which are executed within control device 54 and allow consideration of the torque influences that arise from a start of combustion engine 12.

In block 64, a difference dM_52−M_ist 52−M_zul of the actual value of the torque of electric machine 52 and maximally permitted torque value M_zul depending on driver input FW is formed. In one development, the difference is then weighted in block 66 by rotational speed n_52 of electric machine 52. The result thus represents a deviation of the actual output generated by electric machine 52 in drive train 50 from a limit value of permitted power outputs in drive train 50.

As long as combustion engine 12 makes no torque contribution, only a zero is to be added in logic operations 72 and 74. Furthermore, when clutch 14 is engaged according to FIG. 5, only a zero is to be added in logic operation 72, so that the moment of inertia of combustion engine 12 is not taken into account in this state. This behavior can be achieved by comparing the amount of rotational speed difference dn to thresholds S1 and S2 as switching condition for switches 70 and 68. Rotational speed difference dn is formed from rotational speeds n_12 of combustion engine 12 and n_52 of electric machine 52.

The drawing should be read in such a way that switches 70, 68 are switched from the illustrated switching position to the alternative switching position when the individual statement written above switches 70, 68 is true. Therefore, switch 70 is switched over when the force transmission is achieved at interrupting clutch 14. Switch 68 is switched over following the beginning of a start of combustion engine 12 (instant t=0) until a force transmission is achieved at interrupting clutch 14. The force-transmission rotational speed threshold values S1, S2 may have different values.

Consequently, if combustion engine 12 is stationary, only the torque of electric machine 52 is analyzed.

In block 76, the previously formed deviation from the permitted value is weighted by the 2π-fold multiple of a sampling period T. In this way the deviation formed in block 76 gets the physical dimension of an energy. In block 78, a sum of the values formed for one sampling period T in each case is formed across a plurality of sampling periods T and compared in block 73 to a threshold value SW, which is made available by a block 75. When threshold value SW is exceeded, an error reaction is triggered in block 77. 73, 75, 77 therefore correspond to blocks 38, 40, 42 discussed earlier in the text with reference to FIG. 4.

In the subject matter of FIG. 7, as well, a torque limitation is therefore triggered as error reaction if threshold value SW is exceeded. It is understood that the torque limitation is implemented by interventions in the drive motor that is active in each instance. As long as only electric machine 52 is producing torque, the limitation intervention has to take place for electric machine 52. If combustion engine 12 is active in addition, then the torque limitations are able to be triggered alternatively or additionally by interventions in combustion engine 12.

If combustion engine 12 is connected in addition when electric machine 52 is running, then the torque required to accelerate combustion engine 12 is able to be taken into account by the lower branch of the structure of FIG. 7. To this end, switch 68 is first closed as a function of the comparison of engine speed difference dn with threshold value S2. In one development, it is closed when t>0, i.e., following a beginning of a start of the combustion engine at instant t=0, and for as long as rotational speed difference dn exceeds a threshold value S2, which is the case when the clutch is sliding or disengaged. In block 80, engine speed n_12 (t=0) is squared. In analogous manner, rotational speed n_12 (t=kT) is squared at a later instant t=kT in block 82. T is a sampling period, and k the current number of the sampling periods.

In block 84 the difference of the squared rotational speeds is formed. A block 86 is used to multiply this difference by 2 times the π² of the moment of inertia J_12 of combustion engine 12 (block 89). In other words, the energy required to modify the rotational speed of combustion engine 12 is thereby determined in block 86. Added to this energy in block 88 are frictional losses WLoss (kT) at clutch 14, which are made available by a block 90. Depending on the development, frictional losses WLoss (kT) are approximated by a fixed value or by a characteristics map, which is addressed via the rotational speed difference dn across clutch 14.

The torque contribution of combustion engine 12 generated by the combustion engine by combustions following the frictional connection of clutch 14 is taken into account by the upper branch in FIG. 7, which becomes active as a function of the comparison of rotational speed difference dn with threshold value S1.

In the development of FIG. 7, actual torque value M_ist_12 of combustion engine 12 is therefore multiplied by its rotational speed n_12 in step 90, and added to power output difference dM_52*n_52 via switch 70 to be closed upon frictional connection of clutch 14, and logic operation 74. As a result, the value formed in block 76 is smaller than zero only if, e.g., given equality of rotational speeds of n_52 and n_12, the sum of actual values M_ist_52 of electric machine 52 and M_ist_12 of combustion engine 12 is smaller than permitted limit value M_zul.

What is claimed is:

1. A method for monitoring and limiting at least one of an output and a torque of a drive motor in a drive train of a road motor vehicle, the method comprising:
determining a permitted maximum value of the at least one of the output and the torque as a function of a signal from a driver input sensor;
determining an actual value of the at least one of the output and the torque;
comparing the actual value to the maximum value; and
triggering a measure limiting the at least one of the output and the torque as a function of the comparison result;
wherein the following are performed repeatedly:
a difference is formed from the actual value and the maximum value,
a sum of values of a function of the difference is formed,
a value of the sum is compared to a threshold value, and
the measure is initiated if the value of the sum is greater than the threshold value.

2. The method of claim 1, wherein the function of the difference is the difference itself.

3. The method of claim 1, wherein the function of the difference is formed by weighting the difference by at least one rotational speed of a drive motor of the drive train.

4. The method of claim 1, wherein in a drive train, which has as drive motors an electric machine and a combustion engine acting on the drive train via a controllable clutch, which combustion engine is started by engaging the clutch, an output resulting from a start of the combustion engine and acting in the drive train, or a torque resulting from a start and acting in the drive train, is taken into account when determining the actual value of the output or the torque.

5. The method of claim 4, wherein an output generated by the combustion engine or a torque generated by the combustion engine is taken into account when determining the actual value of the output or the torque in the drive train.

6. The method of claim 4, wherein a moment of inertia, having a braking effect in the start of the combustion engine, of the combustion engine is taken into account when determining the actual value of the output or the torque in the drive train.

7. The method of claim 5, wherein losses occurring at the interrupting clutch in the start of the combustion engine are taken into account when determining the actual value of the output or the torque in the drive train.

8. The method of claim 7, wherein the losses occurring at the clutch are taken into account first, before output contributions or torque contributions of the combustion engine are taken into account at a later point in time.

9. A control device of a drive train of a road motor vehicle for monitoring and limiting at least one of an output and a torque in the drive train, comprising:
a determining arrangement to determine a permissible maximum value of the at least one of the output and the torque as a function of the signal from a driver input sensor;
an ascertaining arrangement to ascertain an actual value of the at least one of the output and the torque;
a comparing arrangement to compare the actual value to the maximum value; and
a triggering arrangement to trigger a measure that limits the at least one of the output and the torque as a function of the comparison result;
wherein the following are performed repeatedly:
a difference is formed from the actual value and the maximum value,
a sum of values is formed as a function of the difference,
a value of the sum is compared to a threshold value, and
the measure is initiated if the value of the sum is greater than the threshold value.

10. The control device 9, wherein the function of the difference is the difference itself.

11. The control device 9, wherein the function of the difference is formed by weighting the difference by at least one rotational speed of a drive motor of the drive train.

12. The control device 9, wherein in a drive train, which has as drive motors an electric machine and a combustion engine acting on the drive train via a controllable clutch, which combustion engine is started by engaging the clutch, an output resulting from a start of the combustion engine and acting in the drive train, or a torque resulting from a start and acting in the drive train, is taken into account when determining the actual value of the output or the torque.

13. The control device 12, wherein an output generated by the combustion engine or a torque generated by the combustion engine is taken into account when determining the actual value of the output or the torque in the drive train.

14. The control device 12, wherein a moment of inertia, having a braking effect in the start of the combustion engine, of the combustion engine is taken into account when determining the actual value of the output or the torque in the drive train.

15. The control device 13, wherein losses occurring at the interrupting clutch in the start of the combustion engine are taken into account when determining the actual value of the output or the torque in the drive train.

16. The control device 15, wherein the losses occurring at the clutch are taken into account first, before output contributions or torque contributions of the combustion engine are taken into account at a later point in time.
